(19) United States
(12) Patent Application Publication
(10) Pub. No.: US 2021/0261745 A1
(43) Pub. Date: Aug. 26, 2021

(54) METHOD FOR PRODUCING A COPOLYMER FOAM WITH POLYAMIDE BLOCKS AND POLYETHER BLOCKS

(71) Applicant: Arkema France, Colombes (FR)

(72) Inventors: Clio COCQUET, SERQUIGNY (FR); Helena CHEMINET, WAUWATOSA, WI (US); Yves DEYRAIL, SERQUIGNY (FR); Audrey DURIN, PIERRE-BENITE Cedex (FR); Marc MIRALLES, SERQUIGNY (FR)

(21) Appl. No.: 17/256,721

(22) PCT Filed: Jul. 2, 2019
(86) PCT No.: PCT/FR2019/051625

§ 371 Date: Dec. 29, 2020

(30) Foreign Application Priority Data
Jul. 3, 2018 (FR) 1856128

(51) Int. Cl. C08J 9/00; C08J 9/12; B29C 44/02; B29C 44/04; B29C 44/34

(52) U.S. Cl. CPC C08J 9/0061; B29C 2945/76531; B29C 44/027; B29C 44/0407; B29C 44/3446; C08J 2203/06; C08J 2371/02; C08J 2377/00; C08J 2423/08; C08J 2431/04; C08J 2433/08; C08J 2433/10; C08G 2110/0066; C08G 2410/00; C08J 9/122

(57) ABSTRACT

The invention relates to a process for manufacturing a copolymer foam containing polyamide blocks and polyether blocks, comprising the following steps:
mixing the copolymer melt with a blowing agent, said copolymer having a coefficient of thermal diffusivity a and a crystallization temperature T_{c};
providing a mold of thickness h at a temperature Tₘ;
injecting the mixture of the copolymer and of the blowing agent at a temperature Tₚ, into the closed mold;
foaming the mixture by opening the mold;
   in which the maintenance time between the injection of the mixture of the copolymer and of the blowing agent into the closed mold and the opening of the mold is within the range extending from (tₒₚₜ−25%) to (tₒₚₜ+25%),
   tₒₚₜ being expressed in seconds and obtained by equation (I):

$${t}_{opt} = - \frac{1}{{π}^{2}} \frac{{h}^{2}}{a} ln ( \frac{π}{4} \frac{{T}_{m} - {T}_{c}}{{T}_{m} - {T}_{p}} ) , \qquad ( I )$$

in which a is expressed in m²/s, h is expressed in m and Tₘ, T_{c} and Tₚ are expressed in ° C.

### FIELD OF THE INVENTION

The present invention relates to a process for manufacturing a foam formed from a copolymer containing polyamide blocks and polyether blocks

### TECHNICAL BACKGROUND

Various polymer foams are used notably in the field of sports equipment, such as soles or sole components, gloves, rackets or golf balls, personal protection items in particular for practicing sports (jackets, interior parts of helmets, shells, etc.). For example, copolymer foams containing polyamide blocks and polyether blocks (or PEB A foams) are particularly suitable for these applications.

Such applications require a set of particular physical properties which ensure rebound capacity, a low compression set and a capacity for enduring repeated impacts without becoming deformed and for returning to the initial shape.

The quality and properties of foams are affected, inter alia, by the process for manufacturing them, notably when they are manufactured by injection molding via the mold-opening technique (the foaming taking place on opening the mold) or the “core-back” technique (the foaming taking place by withdrawing a core inside the mold).

The document by Ries et al., Foam injection molding of thermoplastic elastomers: blowing agents, foaming process and characterization of structural foams, AIP Conference Proceedings, volume 1593, pages 401-410 (2014) discloses a process for the injection molding of a TPE (thermoplastic elastomer) foam using the “core-back” technique, the mold being opened immediately after the molten polymer has filled the mold.

The document by Ishikawa et al., Polypropylene/CO₂ foaming in core-back molding, Society of Plastics Engineers (2011) describes the foaming of a polypropylene using CO₂ via a “core-back” injection-molding process. The mold is opened less than one second after injecting the polymer.

The document by Sporrer et al., Controlling Morphology of Injection Molded Structural Foams by Mold Design and Processing Parameters, Journal of Cellular Plastics, volume 43, pages 313-330 (2007) describes a process for the injection-molding of polypropylene, in which the mold is opened after a delay of 2, 4 or 5 seconds.

FR 3047245 describes PEBA foams obtained via an injection-molding process in which the maintenance time before opening the mold ranges from 25 to 40 s.

There is a real need to provide a process for manufacturing a copolymer foam containing polyamide blocks and polyether blocks, enabling the production of a regular, low-density foam.

### SUMMARY OF THE INVENTION

The invention relates to a process for manufacturing a copolymer foam containing polyamide blocks and polyether blocks, comprising the following steps:
mixing the copolymer melt with a blowing agent, said copolymer having a coefficient of thermal diffusivity a and a crystallization temperature T_{c};
providing a mold of thickness h at a temperature Tₘ;
injecting the mixture of the copolymer and of the blowing agent at a temperature Tₚ, into the closed mold;
foaming the mixture by opening the mold;
   in which the maintenance time between the injection of the mixture of the copolymer and of the blowing agent into the closed mold and the opening of the mold is within the range extending from (tₒₚₜ−25%) to (tₒₚₜ+25%),
   tₒₚₜ being expressed in seconds and obtained by equation (I):

$${t}_{opt} = - \frac{1}{{π}^{2}} \frac{{h}^{2}}{a} ln ( \frac{π}{4} \frac{{T}_{m} - {T}_{c}}{{T}_{m} - {T}_{p}} ) , \qquad ( I )$$

in which a is expressed in m²/s, h is expressed in m and Tₘ, T_{c} and Tₚ are expressed in ° C.

According to certain embodiments, the maintenance time is within the range extending from (tₒₚₜ−20%) to (tₒₚₜ+20%), preferably from (tₒₚₜ−15%) to (tₒₚₜ+15%) and more preferably from (tₒₚₜ−10%) to (tₒₚₜ+10%).

According to certain embodiments, the blowing agent is a physical blowing agent.

According to certain embodiments, the physical blowing agent is chosen from dinitrogen, carbon dioxide, hydrocarbons, chlorofluorocarbons, hydrochlorocarbons, hydrofluorocarbons and hydrochlorofluorocarbons.

According to certain embodiments, the blowing agent is present in the mixture in a mass amount of from 0.1% to 5%, preferably from 0.2% to 2%, even more preferentially from 0.2% to 1%, relative to the sum of the masses of the blowing agent and of the copolymer containing polyamide blocks and polyether blocks.

According to certain embodiments, the polyamide blocks are blocks of polyamide 6, of polyamide 11, of polyamide 12, of polyamide 5.4, of polyamide 5.9, of polyamide 5.10, of polyamide 5.12, of polyamide 5.13, of polyamide 5.14, of polyamide 5.16, of polyamide 5.18, of polyamide 5.36, of polyamide 6.4, of polyamide 6.9, of polyamide 6.10, of polyamide 6.12, of polyamide 6.13, of polyamide 6.14, of polyamide 6.16, of polyamide 6.18, of polyamide 6.36, of polyamide 10.4, of polyamide 10.9, of polyamide 10.10, of polyamide 10.12, of polyamide 10.13, of polyamide 10.14, of polyamide 10.16, of polyamide 10.18, of polyamide 10.36, of polyamide 10.T, of polyamide 12.4, of polyamide 12.9, of polyamide 12.10, of polyamide 12.12, of polyamide 12.13, of polyamide 12.14, of polyamide 12.16, of polyamide 12.18, of polyamide 12.36, of polyamide 12.T or mixtures thereof, or copolymers thereof, preferably of polyamide 11, of polyamide 12, of polyamide 6 or of polyamide 6.10.

According to certain embodiments, the polyether blocks are blocks of polyethylene glycols, of propylene glycol, of polytrimethylene glycol, of polytetrahydrofuran, or mixtures thereof, or copolymers thereof, preferably of polyethylene glycol or of polytetrahydrofuran.

According to certain embodiments:
the polyamide blocks of the copolymer have a number-average molar mass ranging from 100 to 20 000 g/mol, preferably from 200 to 10 000 g/mol, even more preferentially from 200 to 1500 g/mol; and/or
the polyether blocks of the copolymer have a number-average molar mass ranging from 100 to 6000 g/mol, preferably from 200 to 3000 g/mol, even more preferentially from 800 to 2500 g/mol.

According to certain embodiments, the mass ratio of the polyamide blocks relative to the polyether blocks of the copolymer is from 0.1 to 10, preferably from 0.3 to 3, even more preferentially from 0.3 to 0.9.

According to certain embodiments, the process comprises the mixing of the copolymer melt with a blowing agent and with one or more additives, preferably chosen from copolymers of ethylene and of vinyl acetate, copolymers of ethylene and of acrylate, and copolymers of ethylene and of alkyl (meth)acrylate.

According to certain embodiments, the temperature Tₚ is from 170° C. to 300° C., preferably from 180° C. to 250° C.

According to certain embodiments, the temperature Tₘ is from 10° C. to 100° C., preferably from 20° C. to 80° C.

According to certain embodiments, the mold is opened to a length of from 1 to 30 mm, preferably from 2 to 15 mm.

According to certain embodiments, the pressure applied in the mold during the maintenance time is from 100 to 300 MPa, preferably from 150 to 250 MPa.

According to certain embodiments, the foam has a density of less than or equal to 600 kg/m³, preferably less than or equal to 400 kg/m³, more preferentially less than or equal to 300 kg/m³.

The present invention meets the need expressed above. It more particularly provides a process for manufacturing, by injection-molding, an improved copolymer foam containing polyamide blocks and polyether blocks, making it possible to obtain a regular, low-density foam.

This is accomplished by means of applying a specific maintenance time (between the injection of the copolymer melt into the mold and the opening of the mold). This maintenance time is adapted as a function of the coefficient of thermal diffusivity and of the crystallization temperature of the copolymer, of the mold thickness and temperature and of the temperature of the copolymer during its injection.

### BRIEF DESCRIPTION OF THE FIGURES

FIGS. 1A to 1G are images of the molds obtained by injection-molding according to the processes described in Example 1.

FIG. 1A corresponds to a maintenance time of 10 s.

FIG. 1B corresponds to a maintenance time of 20 s.

FIG. 1C corresponds to a maintenance time of 30 s.

FIG. 1D corresponds to a maintenance time of 35 s.

FIG. 1E corresponds to a maintenance time of 40 s.

FIG. 1F corresponds to a maintenance time of 45 s.

FIG. 1G corresponds to a maintenance time of 50 s.

### DESCRIPTION OF EMBODIMENTS OF THE INVENTION

The invention is now described in greater detail and in a nonlimiting manner in the description that follows.

Unless otherwise indicated, all the percentages are mass percentages.

The invention relates to a process for manufacturing a copolymer foam containing polyamide blocks and polyether blocks (or PEBA).

PEBAs result from the polycondensation of polyamide blocks bearing reactive ends with polyether blocks bearing reactive ends, such as, inter alia, the polycondensation:

1) of polyamide blocks bearing diamine chain ends with polyoxyalkylene blocks bearing dicarboxylic chain ends;

2) of polyamide blocks bearing dicarboxylic chain ends with polyoxyalkylene blocks bearing diamine chain ends, obtained, for example, by cyanoethylation and hydrogenation of α,ω-dihydroxylated aliphatic polyoxyalkylene blocks, known as polyetherdiols;

3) of polyamide blocks bearing dicarboxylic chain ends with polyetherdiols, the products obtained being, in this particular case, polyetheresteramides.

The polyamide blocks bearing dicarboxylic chain ends originate, for example, from the condensation of polyamide precursors in the presence of a chain-limiting dicarboxylic acid. The polyamide blocks bearing diamine chain ends originate, for example, from the condensation of polyamide precursors in the presence of a chain-limiting diamine.

Three types of polyamide blocks may advantageously be used.

According to a first type, the polyamide blocks originate from the condensation of a dicarboxylic acid, in particular those containing from 4 to 20 carbon atoms, preferably those containing from 6 to 18 carbon atoms, and of an aliphatic or aromatic diamine, in particular those containing from 2 to 20 carbon atoms, preferably those containing from 6 to 14 carbon atoms.

As examples of dicarboxylic acids, mention may be made of 1,4-cyclohexanedicarboxylic acid, butanedioic acid, adipic acid, azelaic acid, suberic acid, sebacic acid, dodecanedicarboxylic acid, octadecanedicarboxylic acid, terephthalic acid and isophthalic acid, but also dimerized fatty acids.

As examples of diamines, mention may be made of tetramethylenediamine, hex amethylenediamine, 1,10-decamethylenediamine, dodecamethylenediamine, trimethylhexamethylenediamine, the isomers of bis(4-aminocyclohexyl)methane (BALM), bis(3-methyl-4-aminocyclohexyl)methane (BMACM) and 2,2-bis(3-methyl-4-aminocyclohexyl)propane (BMACP), para-aminodicyclohexylmethane (PACM), isophoronediamine (IPDA), 2,6-bis(aminomethyl)norbornane (BAMN) and piperazine (Pip).

Advantageously, polyamide blocks PA 4.12, PA 4.14, PA 4.18, PA 6.10, PA 6.12, PA 6.14, PA 6.18, PA 9.12, PA 10.10, PA 10.12, PA 10.14 and PA 10.18 are used. In the notation PA X.Y, X represents the number of carbon atoms derived from the diamine residues and Y represents the number of carbon atoms derived from the diacid residues, as is conventional.

According to a second type, the polyamide blocks result from the condensation of one or more α,ω-aminocarboxylic acids and/or of one or more lactams containing from 6 to 12 carbon atoms in the presence of a dicarboxylic acid containing from 4 to 12 carbon atoms or of a diamine. As examples of lactams, mention may be made of caprolactam, oenantholactam and lauryllactam. As examples of α,ω-aminocarboxylic acids, mention may be made of aminocaproic acid, 7-aminoheptanoic acid, 11-aminoundecanoic acid and 12-aminododecanoic acid.

Advantageously, the polyamide blocks of the second type are PA 11 (polyundecanamide), PA 12 (polydodecanamide) or PA 6 (polycaprolactam) blocks. In the notation PA X, X represents the number of carbon atoms derived from amino acid residues.

According to a third type, the polyamide blocks result from the condensation of at least one α,ω-aminocarboxylic acid (or a lactam), at least one diamine and at least one dicarboxylic acid.

In this case, the polyamide PA blocks are prepared by polycondensation:
of the linear aliphatic or aromatic diamine(s) containing X carbon atoms;
of the dicarboxylic acid(s) containing Y carbon atoms; and
of the comonomer(s) {Z}, chosen from lactams and α,ω-aminocarboxylic acids containing Z carbon atoms and equimolar mixtures of at least one diamine containing X1 carbon atoms and of at least one dicarboxylic acid containing Y1 carbon atoms, (X1, Y1) being different from (X, Y);
said comonomer(s) {Z} being introduced in a weight proportion advantageously ranging up to 50%, preferably up to 20%, even more advantageously up to 10% relative to the total amount of polyamide-precursor monomers;
in the presence of a chain limiter chosen from dicarboxylic acids.

Advantageously, the dicarboxylic acid containing Y carbon atoms is used as chain limiter, which is introduced in excess relative to the stoichiometry of the diamine(s).

According to one variant of this third type, the polyamide blocks result from the condensation of at least two α,ω-aminocarboxylic acids or from at least two lactams containing from 6 to 12 carbon atoms or from one lactam and one aminocarboxylic acid not having the same number of carbon atoms, in the optional presence of a chain limiter. As examples of aliphatic α,ω-aminocarboxylic acids, mention may be made of aminocaproic acid, 7-aminoheptanoic acid, 11-aminoundecanoic acid and 12-aminododecanoic acid. As examples of lactams, mention may be made of caprolactam, oenantholactam and lauryllactam. As examples of aliphatic diamines, mention may be made of hexamethylenediamine, dodecamethylenediamine and trimethylhexamethylenediamine. As examples of cycloaliphatic diacids, mention may be made of 1,4-cyclohexanedicarboxylic acid. As examples of aliphatic diacids, mention may be made of butanedioic acid, adipic acid, azelaic acid, suberic acid, sebacic acid, dodecanedicarboxylic acid and dimerized fatty acids. These dimerized fatty acids preferably have a dimer content of at least 98%; they are preferably hydrogenated; they are, for example, products sold under the brand name Pripol by the company Croda, or under the brand name Empol by the company BASF, or under the brand name Radiacid by the company Oleon, and polyoxyalkylene am-diacids. As examples of aromatic diacids, mention may be made of terephthalic acid (T) and isophthalic acid (I). As examples of cycloaliphatic diamines, mention may be made of the isomers bis(4-aminocyclohexyl)methane (BACM), bis(3-methyl-4-aminocyclohexyl)methane (BMACM) and 2,2-bis(3-methyl-4-aminocyclohexyl)propane (BMACP), and para-aminodicyclohexylmethane (PACM). The other diamines commonly used may be isophoronediamine (IPDA), 2,6-bis(aminomethyl)norbornane (BAMN) and piperazine.

As examples of polyamide blocks of the third type, mention may be made of the following:
PA 6.6/6, in which 6.6 denotes hexamethylenediamine units condensed with adipic acid and 6 denotes units resulting from the condensation of caprolactam;
PA 6.6/6.10/11/12 in which 6.6 denotes hexamethylenediamine condensed with adipic acid, 6.10 denotes hexamethylenediamine condensed with sebacic acid, and 11 denotes units resulting from the condensation of aminoundecanoic acid, and 12 denotes units resulting from the condensation of lauryllactam.

The notations PA X/Y, PA X/Y/Z, etc. relate to copolyamides in which X, Y, Z, etc. represent homopolyamide units as described above.

Advantageously, the polyamide blocks of the copolymer used in the invention comprise polyamide PA 6, PA 11, PA 12, PA 5.4, PA 5.9, PA 5.10, PA 5.12, PA 5.13, PA 5.14, PA 5.16, PA 5.18, PA 5.36, PA 6.4, PA 6.9, PA 6.10, PA 6.12, PA 6.13, PA 6.14, PA 6.16, PA 6.18, PA 6.36, PA 10.4, PA 10.9, PA 10.10, PA 10.12, PA 10.13, PA 10.14, PA 10.16, PA 10.18, PA 10.36, PA 10.T, PA 12.4, PA 12.9, PA 12.10, PA 12.12, PA 12.13, PA 12.14, PA 12.16, PA 12.18, PA 12.36 or PA 12.T blocks, or mixtures or copolymers thereof; and preferably comprise polyamide PA 6, PA 11, PA 12, PA 6.10, PA 10.10 or PA 10.12 blocks, or mixtures or copolymers thereof.

The polyether blocks are formed from alkylene oxide units.

The polyether blocks may notably be PEG (polyethylene glycol) blocks, i.e. blocks formed from ethylene oxide units, and/or PPG (propylene glycol) blocks, i.e. blocks formed from propylene oxide units, and/or PO3G (polytrimethylene glycol) blocks, i.e. blocks formed from polytrimethylene glycol ether units, and/or PTMG blocks, i.e. blocks formed from tetramethylene glycol units, also known as polytetrahydrofuran. The PEBA copolymers may comprise in their chain several types of polyethers, the copolyethers possibly being in block or statistical form.

Use may also be made of blocks obtained by oxyethylation of bisphenols, for instance bisphenol A. The latter products are notably described in EP 613 919.

The polyether blocks may also be formed from ethoxylated primary amines. As examples of ethoxylated primary amines, mention may be made of the products of formula:

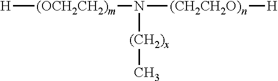

in which m and n are integers between 1 and 20, and x is an integer between 8 and 18. These products are commercially available under the brand name Noramox® from the company CECA and under the brand name Genamin® from the company Clamant.

The flexible polyether blocks may comprise polyoxyalkylene blocks bearing NH₂ chain ends, such blocks being able to be obtained by cyanoacetylation of α,ω-dihydroxylated aliphatic polyoxyalkylene blocks referred to as polyetherdiols. More particularly, the commercial products Jeffamine or Elastamine may be used (for example Jeffamine® D400, D2000, ED 2003, XTJ 542, which are commercial products from the company Huntsman, also described in JP 2004/346274, JP 2004/352794 and EP 1482011).

The polyether diol blocks are either used in unmodified form and copolycondensed with polyamide blocks bearing carboxylic end groups, or are aminated to be converted into polyetherdiamines and condensed with polyamide blocks bearing carboxylic end groups. The general method for the two-step preparation of PEBA copolymers containing ester bonds between the PA blocks and the PE blocks is known and is described, for example, in FR 2846332. The general method for the preparation of the PEBA copolymers of the invention containing amide bonds between the PA blocks and the PE blocks is known and is described, for example, in EP 1482011. The polyether blocks may also be mixed with polyamide precursors and a chain-limiting diacid to prepare polymers containing polyamide blocks and polyether blocks having randomly distributed units (one-step process).

Needless to say, the name PEBA in the present description of the invention relates not only to the Pebax® products sold by Arkema, to the Vestamid® products sold by Evonik® and to the Grilamid® products sold by EMS, but also to the Pelestat® type PEBA products sold by Sanyo or to any other PEBA from other suppliers.

If the block copolymers described above generally comprise at least one polyamide block and at least one polyether block, the present invention also covers all the copolymer alloys comprising two, three, four (or even more) different blocks chosen from those described in the present description, provided that these blocks include at least polyamide and polyether blocks.

For example, the copolymer alloy according to the invention may comprise a segmented copolymer containing blocks comprising three different types of blocks (or “triblock” copolymer), which results from the condensation of several of the blocks described above. Said triblock copolymer is preferably chosen from copolyetherester amides and copolyether amide urethanes.

PEBA copolymers that are particularly preferred in the context of the invention are copolymers including blocks from among:
PA 11 and PEG;
PA 11 and PTMG;
PA 12 and PEG;
PA 12 and PTMG;
PA 6.10 and PEG;
PA 6.10 and PTMG;
PA 6 and PEG;
PA 6 and PTMG.

The foam obtained via the process according to the invention includes a PEBA copolymer as described above: preferably, only one such copolymer is used. It is, however, possible to use a mixture of two or more than two PEBA copolymers as described above.

The number-average molar mass of the polyamide blocks in the PEBA copolymer is preferably from 100 to 20 000 g/mol, more preferentially from 200 to 10 000 g/mol and even more preferentially from 200 to 1500 g/mol. In certain embodiments, the number-average molar mass of the polyamide blocks in the PEBA copolymer is from 100 to 200 g/mol, or from 200 to 500 g/mol, or from 500 to 1000 g/mol, or from 1000 to 1500 g/mol, or from 1500 to 2000 g/mol, or from 2000 to 2500 g/mol, or from 2500 to 3000 g/mol, or from 3000 to 3500 g/mol, or from 3500 to 4000 g/mol, or from 4000 to 5000 g/mol, or from 5000 to 6000 g/mol, or from 6000 to 7000 g/mol, or from 7000 to 8000 g/mol, or from 8000 to 9000 g/mol, or from 9000 to 10 000 g/mol, or from 10 000 to 11 000 g/mol, or from 11 000 to 12 000 g/mol, or from 12 000 to 13 000 g/mol, or from 13 000 to 14 000 g/mol, or from 14 000 to 15 000 g/mol, or from 15 000 to 16 000 g/mol, or from 16 000 to 17 000 g/mol, or from 17 000 to 18 000 g/mol, or from 18 000 to 19 000 g/mol, or from 19 000 to 20 000 g/mol.

The number-average molar mass of the polyether blocks is preferably from 100 to 6000 g/mol, more preferentially from 200 to 3000 g/mol and even more preferentially from 800 to 2500 g/mol. In certain embodiments, the number-average molar mass of the polyether blocks is from 100 to 200 g/mol, or from 200 to 500 g/mol, or from 500 to 800 g/mol, or from 800 to 1000 g/mol, or from 1000 to 1500 g/mol, or from 1500 to 2000 g/mol, or from 2000 to 2500 g/mol, or from 2500 to 3000 g/mol, or from 3000 to 3500 g/mol, or from 3500 to 4000 g/mol, or from 4000 to 4500 g/mol, or from 4500 to 5000 g/mol, or from 5000 to 5500 g/mol, or from 5500 to 6000 g/mol.

The number-average molecular mass is set by the content of chain limiter. It may be calculated according to the equation:

Mₙ=nₘₒₙₒₘₑᵣ×MW_{repeating unit}/n_{chain limiter}+MW_{chain limiter}

In this formula, nₘₒₙₒₘₑᵣ represents the number of moles of monomer, n_{chain} limiter represents the number of moles of limiter (for example diacid) in excess, MW_{repeating unit} represents the molar mass of the repeating unit, and MW_{chain limiter} represents the molar mass of the limiter (for example diacid) in excess.

The number-average molar mass of the polyamide blocks and of the polyether blocks may be measured before the copolymerization of the blocks by gel permeation chromatography (GPC).

Advantageously, the mass ratio of the polyamide blocks relative to the polyether blocks of the copolymer is from 0.1 to 10, preferably from 0.3 to 3, even more preferentially from 0.3 to 0.9. In particular, the mass ratio of the polyamide blocks relative to the polyether blocks of the copolymer may be from 0.1 to 0.2, or from 0.2 to 0.3, or from 0.3 to 0.4, or from 0.4 to 0.5, or from 0.5 to 0.6, or from 0.6 to 0.7, or from 0.7 to 0.8, or from 0.8 to 0.9, or from 0.9 to 1, or from 1 to 1.5, or from 1.5 to 2, or from 2 to 2.5, or from 2.5 to 3, or from 3 to 3.5, or from 3.5 to 4, or from 4 to 4.5, or from 4.5 to 5, or from 5 to 5.5, or from 5.5 to 6, or from 6 to 6.5, or from 6.5 to 7, or from 7 to 7.5, or from 7.5 to 8, or from 8 to 8.5, or from 8.5 to 9, or from 9 to 9.5, or from 9.5 to 10.

Preferably, the copolymer used in the invention has an instantaneous hardness of less than or equal to 40 Shore D, more preferably less than or equal to 35 Shore D. The hardness measurements may be performed according to the standard ISO 868.

The copolymer used in the invention has a coefficient of thermal diffusivity a and a crystallization temperature T_{c}.

The coefficient of thermal diffusivity may be measured by the transient plane heat source method according to the standard ISO 22007 2: 2008, using the Hot Disk device. The crystallization temperature may be measured by differential scanning calorimetry (DSC).

The DSC measurements are performed with the following parameters:
equilibration at −80° C.;
heating at 20° C./minute up to 240° C.;
cooling at 20° C./minute down to −80° C.;
heating at 20° C./minute up to 240° C.

The process according to the invention comprises a step of mixing the copolymer as described above, in molten form, and with a blowing agent.

The blowing agent may be a chemical or physical agent. Preferably, it is a physical agent, for instance dinitrogen or carbon dioxide, or a hydrocarbon, chlorofluorocarbon, hydrochlorocarbon, hydrofluorocarbon or hydrochlorofluorocarbon (saturated or unsaturated). For example, butane or pentane may be used.

The physical blowing agent is mixed with the copolymer in liquid or supercritical form and then converted into the gaseous phase during the foaming step.

The blowing agent is preferably present in the mixture in a mass amount of from 0.1% to 5%, preferably from 0.2% to 2%, even more preferentially from 0.2% to 1%, relative to the sum of the masses of the blowing agent and of the copolymer containing polyamide blocks and polyether blocks. Notably, the blowing agent may be present in a mass amount of from 0.1% to 0.2%, or from 0.2% to 0.3%, or from 0.3% to 0.4%, or from 0.4% to 0.5%, or from 0.5% to 0.6%, or from 0.6% to 0.7%, or from 0.7% to 0.8%, or from 0.8% to 0.9%, or from 0.9% to 1%, or from 1% to 1.5%, or from 1.5% to 2%, or from 2% to 2.5%, or from 2.5% to 3%, or from 3% to 3.5%, or from 3.5% to 4%, or from 4% to 4.5%, or from 4.5% to 5%, relative to the sum of the masses of the blowing agent and of the copolymer containing polyamide blocks and polyether blocks.

The copolymer containing polyamide blocks and polyether blocks may be combined with various additives, for example copolymers of ethylene and vinyl acetate or EVA (for example those sold under the name Evatane® by Arkema), or copolymers of ethylene and of acrylate, or copolymers of ethylene and of alkyl (meth)acrylate, for example those sold under the name Lotryl® by Arkema. These additives may make it possible to adjust the hardness of the foamed part, its appearance and its comfort. The additives may be added in a content of from 0 to 50% by mass, preferentially from 5% to 30% by mass, relative to the copolymer containing polyamide blocks and polyether blocks.

The process according to the invention also comprises a step of providing a mold at a temperature Tₘ. In certain embodiments, Tₘ is from 10 to 100° C., preferably from 20° C. to 80° C. In particular, the mold temperature Tₘ may be from 10 to 20° C., or from 20 to 30° C., or from 30 to 40° C., or from 40 to 50° C., or from 50 to 60° C., or from 60 to 70° C., or from 70 to 80° C., or from 80 to 90° C., or from 90 to 100° C.

The mold is a mold that is suitable for performing a process of injection molding using the mold-opening technique (the foaming taking place by opening the mold) or the “core-back” technique (the foaming taking place by withdrawing a core inside the mold). It may have any possible shape but preferably has a parallelepipedal shape. It has a thickness h. The term thickness of the mold means the mean thickness of the mold cavity when it is closed. The thickness is the mold dimension that is parallel to the direction of opening of the mold.

The process according to the invention comprises a step of injecting the mixture of the copolymer and of the blowing agent (and optionally of the additives) into the closed mold. During the injection, the mold is at the temperature Tₘ.

The mixture comprising the copolymer is injected into the mold at a temperature Tₚ. In the present patent application, the temperature of the mixture is likened to the temperature of the copolymer (these two temperatures are identical). The temperature Tₚ may have a value from 170° C. to 300° C., preferably from 180° C. to 250° C. In certain embodiments, the temperature Tₚ is from 170 to 180° C., or from 180 to 190° C., or from 190 to 200° C., or from 200 to 210° C., or from 210 to 220° C., or from 220 to 230° C., or from 230 to 240° C., or from 240 to 250° C., or from 250 to 260° C., or from 260 to 270° C., or from 270 to 280° C., or from 280 to 290° C., or from 290 to 300° C.

The process according to the invention also comprises a step of foaming the mixture, this being performed by opening the mold. During the opening of the mold, preferably over a certain distance (i.e. the mold is opened by a certain length), the pressure maintained in the mold when it was closed decreases, which brings about the foaming of the mixture.

Preferably, the mold is opened to a length of from 1 to 5 mm, or from 5 to 10 mm, or from 10 to 15 mm, or from 15 to 20 mm, or from 20 to 25 mm, or from 25 to 30 mm. An opening of a length of from 1 to 30 mm or from 2 to 15 mm is particularly preferred.

According to the invention, the maintenance time, i.e. the time between the injection of the mixture (more precisely the end of the injection) into the mold and the opening of the mold (more precisely the start of opening) is within the range extending from (tₒₚₜ−25%) to (tₒₚₜ+25%),

tₒₚₜ being expressed in seconds and obtained by equation (I):

$${t}_{opt} = - \frac{1}{{π}^{2}} \frac{{h}^{2}}{a} ln ( \frac{π}{4} \frac{{T}_{m} - {T}_{c}}{{T}_{m} - {T}_{p}} ) , \qquad ( I )$$

in which a is expressed in m²/s, h is expressed in m and Tₘ, T_{c} and Tₚ are expressed in ° C.

In certain embodiments, the maintenance time is within the range extending from (tₒₚₜ−25%) to (tₒₚₜ−22%), or from (tₒₚₜ−22%) to (tₒₚₜ−20%), or from (tₒₚₜ−20%) to (tₒₚₜ−17%), or from (tₒₚₜ−17%) to (tₒₚₜ−15%), or from (tₒₚₜ−15%) to (tₒₚₜ−12%), or from (tₒₚₜ−12%) to (tₒₚₜ−10%), or from (tₒₚₜ−10%) to (tₒₚₜ−7%), or from (tₒₚₜ−7%) to (tₒₚₜ−5%), or from (tₒₚₜ−5%) to (tₒₚₜ−2%), or from (tₒₚₜ−2%) to (tₒₚₜ−1%), or from (tₒₚₜ−1%) to tₒₚₜ s, or from tₒₚₜ s to (tₒₚₜ+1%), or from (tₒₚₜ+1%) to (tₒₚₜ+2%), or from (tₒₚₜ+2%) to (tₒₚₜ+5%), or from (tₒₚₜ+5%) to (tₒₚₜ+7%), or from (tₒₚₜ+7%) to (tₒₚₜ+10%), or from (tₒₚₜ+10%) to (tₒₚₜ+12%), or from (tₒₚₜ+12%) to (tₒₚₜ+15%), or from (tₒₚₜ+15%) to (tₒₚₜ+17%), or from (tₒₚₜ+17%) to (tₒₚₜ+20%), or from (tₒₚₜ+20%) to (tₒₚₜ+22%), or from (tₒₚₜ+22%) to (tₒₚₜ+25%). A particularly preferred maintenance time range is from (tₒₚₜ−20%) to (tₒₚₜ+20%). In certain embodiments, the maintenance time may be approximately tₒₚₜ.

Advantageously, pressure is applied in the closed mold, during the maintenance time, for example a pressure of from 100 to 150 MPa, or from 150 to 200 MPa, or from 200 to 250 MPa, or from 250 to 300 MPa. Preferred ranges are from 100 to 300 MPa, or from 150 to 250 MPa.

Preferably, the process according to the invention comprises a step of cooling the mold, for example in ambient air, for example to room temperature. The process may also comprise a step of stripping the foam from the mold, preferably after the foam has been cooled, for example to room temperature.

Preferably, the process according to the invention does not comprise a crosslinking step and the foam produced is not crosslinked.

The foam produced according to the invention preferably has a density of less than or equal to 600 kg/m³, more preferentially less than or equal to 500 kg/m³, even more preferentially less than or equal to 400 kg/m³ and particularly preferably less than or equal to 300 kg/m³. For example, the density of the foam may be from 50 to 600 kg/m³, or from 100 to 400 kg/m³, and more particularly preferably from 150 to 300 kg/m³.

Preferably, this foam has a rebound resilience, according to the standard ISO 8307, of greater than or equal to 55%.

Preferably, this foam has a compression set, according to the standard ISO 7214, of less than or equal to 10% and more particularly preferably less than or equal to 8%.

Preferably, this foam also has excellent properties in terms of fatigue resistance and dampening.

The foam produced according to the invention may be used for manufacturing sports equipment, such as sports shoe soles, ski shoes, midsoles, insoles or functional sole components, in the form of inserts in the various parts of the sole (for example the heel or the arch), or shoe upper components in the form of reinforcements or inserts into the structure of the shoe upper, or in the form of protections.

It may also be used for manufacturing inflatable balls, sports gloves (for example football gloves), golf ball components, rackets, protective elements (jackets, helmet interior elements, shells, etc.).

The foam produced according to the invention may have advantageous impact-resistance, vibration-resistance and anti-noise properties, combined with haptic properties suitable for capital goods. It may thus also be used for manufacturing railway rail soles, or various parts in the motor vehicle industry, in transport, in electrical and electronic equipment, in construction or in the manufacturing industry.

These foam objects according to the invention can be readily recycled, for example by melting them in an extruder equipped with a degassing outlet (optionally after having chopped them into pieces).

### EXAMPLES

The examples that follow illustrate the invention without limiting it.

### Example 1

Foams formed from a PEBA copolymer are manufactured using an Arburg Allrounder 270C injection press, with a system for injecting a physical blowing agent of Trexel series II type. The operating parameters are as follows:
Sheath temperature: from 50 to 230° C. (from the feed hopper to the injector nozzle); the temperature of the injected mixture may be likened to the sheath temperature at the injector nozzle;
Injection speed: 80 cm³;
Maintenance time before opening the mold: 10, 20, 30, 35, 40, 45 or 50 s;
Maintenance pressure: 150 MPa;
Cooling time: 100 s;
Mold temperature: 60° C.;
Mold opening length: 12 mm;
Mold opening speed: 20 mm/s;
Mold thickness: 3 mm.

The foaming agent used is dinitrogen, introduced to a proportion of 0.6% by weight.

The PEBA is a copolymer containing PA11 blocks and PTMG blocks, with a density of 1.02 g/cm³, having a melting point of 135° C. and a hardness of 32 Shore D. Its crystallization temperature is 63° C. and its coefficient of thermal diffusivity is 1.22×10⁻⁷ m²/s.

The parameter tₒₚₜ calculated by formula (I) is 32 s.

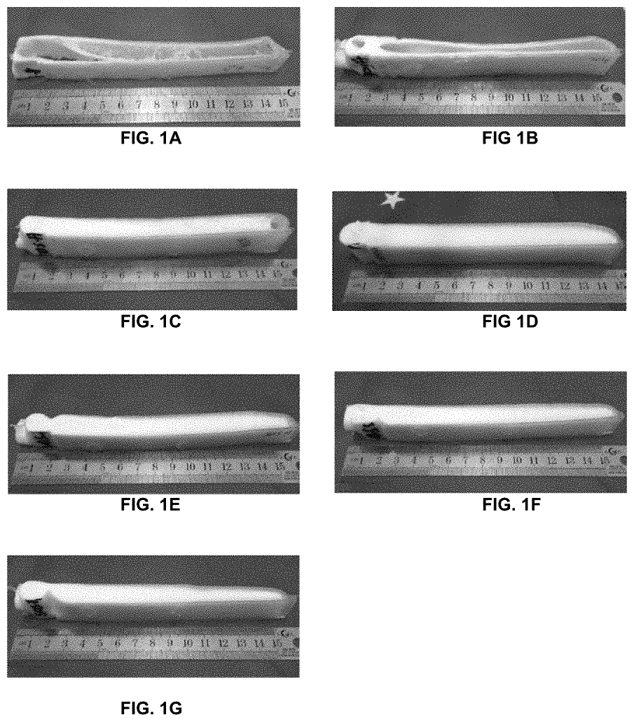

The results are presented in FIGS. 1A to 1G.

It is observed that when a maintenance time of 10 or 20 s is applied, a foam with a hollow core is obtained: such a foam is thus unsatisfactory. When the maintenance time is 50 s, the expansion of the foam is non-uniform.

In contrast, with a maintenance time of 35 s, it is observed that the foam obtained has a uniform thickness and does not have a hollow core.

### Example 2

Foams formed from a PEBA copolymer denoted A or from a PEBA copolymer denoted B are manufactured using an Arburg Allrounder 270C injection press, with a system for injecting a physical blowing agent of Trexel series II type. The operating parameters are as follows:
Sheath temperature (which may be likened to the temperature of the injected mixture): modifiable parameter;
Injection speed: 112 cm³;
Maintenance time before opening the mold: modifiable parameter;
Cooling time: 120 to 180 s;
Mold temperature: modifiable parameter;
Mold opening length: up to 12 mm;
Mold opening speed: 50 mm/s;
Total cycle time: 145 to 220 s.

The foaming agent used is dinitrogen, introduced to a proportion of 0.6% by weight.

PEBA A is a copolymer containing PA11 blocks and PTMG blocks, with a density of 1.02 g/cm³, having a melting point of 135° C. and a hardness of 32 Shore D. Its crystallization temperature is 63° C. and its coefficient of thermal diffusivity is 1.23×10⁻⁷ m²/s.

PEBA B is a copolymer containing PA11 blocks and PTMG blocks, with a density of 1.03 g/cm³, having a melting point of 148° C. and a hardness of 39 Shore D. Its crystallization temperature is 90° C. and its coefficient of thermal diffusivity is 1.22×10⁻⁷ m²/s.

The parameters of the manufacturing processes used are summarized in the table below:

| Process | | Mold temperature | PEBA tem- | Mold thickness |
|---|---|---|---|---|
| No. | PEBA | (° C.) | perature (° C.) | (mm) |
| 1 | A | 35 | 210 | 3 |
| 2 | A | 60 | 210 | 3 |
| 3 | A | 50 | 210 | 5 |
| 4 | B | 60 | 240 | 3 |

The results are summarized in the table below:

| | | tₒₚₜ (s) | | |
|---|---|---|---|---|
| | | obtained | | |
| Foam | Process | by formula | Maintenance | |
| No. | employed | (I) | time applied | Description of the foam |
| 1A | 1 | 15 | 17; 18 | Homogeneous part with a |
| | | | | density of 0.2 g/cm³ |
| 1B | 1 | 15 | 10 | Hollow part |
| 1C | 1 | 15 | 30 | Part not sufficiently |
| | | | | expanded, i.e. with a density |
| | | | | of 0.7 g/cm³ |
| 2A | 2 | 31 | 24; 25; 26; | Homogeneous part with a |
| | | | 27; 28 | density of 0.2 g/cm³ |
| 2B | 2 | 31 | 10 | Hollow part |
| 2C | 2 | 31 | 40 | Part not sufficiently |
| | | | | expanded, i.e. with a density |
| | | | | of 0.8 g/cm³ |
| 3A | 3 | 57 | 55 | Homogeneous part of |
| | | | | density = 0.2 g/cm³ |
| 3B | 3 | 57 | 25 | Hollow part |
| 3C | 3 | 57 | 90 | Part not sufficiently |
| | | | | expanded, i.e. with a density |
| | | | | of 0.8 g/cm³ |
| 4A | 4 | 15 | 16; 17; 18 | Homogeneous part of |
| | | | | density = 0.2 g/cm³ |
| 4B | 4 | 15 | 10 | Hollow part |
| 4C | 4 | 15 | 30 | Part not sufficiently |
| | | | | expanded, i.e. with a density |
| | | | | of 0.85 g/cm³ |

Foams 1A, 2A, 3A and 4A are produced via a process according to the invention. Foams 1B, 1C, 2B, 2C, 3B, 3C, 4B and 4C are counterexamples.

1. A process for manufacturing a copolymer foam containing polyamide blocks and polyether blocks, comprising the following steps:
mixing the copolymer melt with a blowing agent, said copolymer having a coefficient of thermal diffusivity a and a crystallization temperature T_{c};
providing a closed mold of thickness h at a temperature Tₘ;
injecting the mixture of the copolymer and of the blowing agent at a temperature Tₚ, into the closed mold;
foaming the mixture by opening the mold;
in which the maintenance time between the injection of the mixture of the copolymer and of the blowing agent into the closed mold and the opening of the mold is within the range extending from (tₒₚₜ−25%) to (tₒₚₜ+25%), tₒₚₜ being expressed in seconds and obtained by equation (I):
$${t}_{opt} = - \frac{1}{{π}^{2}} \frac{{h}^{2}}{a} ln ( \frac{π}{4} \frac{{T}_{m} - {T}_{c}}{{T}_{m} - {T}_{p}} ) \qquad ( I )$$
in which a is expressed in m²/s, h is expressed in m and Tₘ, T_{c} and Tₚ are expressed in ° C.

2. The process as claimed in claim 1, in which the maintenance time is within the range extending from (tₒₚₜ−20%) to (tₒₚₜ+20%).

3. The process as claimed in claim 1, wherein the blowing agent is a physical blowing agent.

4. The process as claimed in claim 3, wherein the blowing agent is chosen from dinitrogen, carbon dioxide, hydrocarbons, chlorofluorocarbons, hydrochlorocarbons, hydrofluorocarbons and hydrochlorofluorocarbons.

5. The process as claimed in claim 1, wherein the blowing agent is present in the mixture in a mass amount of from 0.1% to 5%, relative to the sum of the masses of the blowing agent and of the copolymer containing polyamide blocks and polyether blocks.

6. The process as claimed in claim 1, wherein the polyamide blocks are blocks of polyamide 6, of polyamide 11, of polyamide 12, of polyamide 5.4, of polyamide 5.9, of polyamide 5.10, of polyamide 5.12, of polyamide 5.13, of polyamide 5.14, of polyamide 5.16, of polyamide 5.18, of polyamide 5.36, of polyamide 6.4, of polyamide 6.9, of polyamide 6.10, of polyamide 6.12, of polyamide 6.13, of polyamide 6.14, of polyamide 6.16, of polyamide 6.18, of polyamide 6.36, of polyamide 10.4, of polyamide 10.9, of polyamide 10.10, of polyamide 10.12, of polyamide 10.13, of polyamide 10.14, of polyamide 10.16, of polyamide 10.18, of polyamide 10.36, of polyamide 10.T, of polyamide 12.4, of polyamide 12.9, of polyamide 12.10, of polyamide 12.12, of polyamide 12.13, of polyamide 12.14, of polyamide 12.16, of polyamide 12.18, of polyamide 12.36, of polyamide 12.T or mixtures thereof, or copolymers thereof, preferably of polyamide 11, of polyamide 12, of polyamide 6 or of polyamide 6.10.

7. The process as claimed in claim 1, wherein the polyether blocks are blocks of polyethylene glycol, of propylene glycol, of polytrimethylene glycol, of polytetrahydrofuran, or mixtures thereof, or copolymers thereof.

8. The process as claimed in claim 1, wherein:
the polyamide blocks of the copolymer have a number-average molar mass ranging from 100 to 20 000 g/mol, and/or
the polyether blocks of the copolymer have a number-average molar mass ranging from 100 to 6000 g/mol.

9. The process as claimed claim 1, wherein the mass ratio of the polyamide blocks relative to the polyether blocks of the copolymer is from 0.1 to 10.

10. The process as claimed in claim 1, wherein the mixing of the copolymer melt with a blowing agent further comprises the mixing of one or more additives with said copolymer and blowing agent.

11. The process as claimed in claim 1, wherein the temperature Tₚ is from 170° C. to 300° C.

12. The process as claimed in claim 1, wherein the temperature Tₘ is from 10° C. to 100° C.

13. The process as claimed in claim 1, wherein the mold is opened to a length of from 1 to 30 mm.

14. The process as claimed in claim 1, wherein the pressure applied in the mold during the maintenance time is from 100 to 300 MPa.

15. The process as claimed in claim 1, wherein the foam has a density of less than or equal to 600 kg/m³.

16. The process as claimed in claim 10, wherein said additives are selected from the group consisting of copolymers of ethylene and of vinyl acetate, copolymers of ethylene and of acrylate, and copolymers of ethylene and of alkyl (meth)acrylate.
